(19) United States
(12) Patent Application Publication
(10) Pub. No.: US 2009/0139690 A1
(43) Pub. Date: Jun. 4, 2009

(54) HEAT SINK AND METHOD FOR PRODUCING A HEAT SINK

(75) Inventors: Martin MAERZ, Nuernberg (DE); Dimitar Tchobanov, Nuernberg (DE); Bernd Eckhardt, Nuernberg (DE); Stefan Zeltner, Erlangen (DE); Sven Egelkraut, Chemnitz (DE); Simon Amesoeder, Nuernberg (DE)

Correspondence Address: GLENN PATENT GROUP, 3475 EDISON WAY, SUITE L, MENLO PARK, CA, 94025, US

(73) Assignee: Fraunhofer-Gesellschaft zur, Foerderung der angewandten, Forschung e. V., Munich (DE)

(21) Appl. No.: 12/323,429

(22) Filed: Nov. 25, 2008

(30) Foreign Application Priority Data
Nov. 29, 2007 (DE) 102007057533.7

(51) Int. Cl. F28F 7/00; F28F 13/18; B21D 53/02; B23P 11/00

(52) U.S. Cl. 165/80.2; 165/185; 165/133; 29/890.03; 29/428

(57) ABSTRACT

A heat sink includes a base body of an electrically insulating material and one or several metallic molded parts having a mounting portion and a heat-transfer portion, wherein the heat-transfer portion is mechanically connected to the base body. The heat sink can be inserted on a printed circuit board having several heat sources that can be at different electrical potentials, wherein the mounting portions of the molded parts are soldered to respective heat sources or close to the respective heat sources.

### CROSS-REFERENCE TO RELATED APPLICATIONS

This application claims priority from German Patent Application No. 102007057533.7, which was filed on Nov. 29, 2007, and is incorporated herein in its entirety by reference.

### BACKGROUND OF THE INVENTION

The invention relates to a heat sink and, particularly, to a heat sink for electronic circuits and a method for producing the same.

Heat sinks are frequently used for cooling electronic circuits. It is the object of a heat sink to improve heat dissipation by increasing the surface. Thereby, heat dissipation can take place both via convection—to a liquid or gaseous cooling medium—and by radiation.

Metal heat sinks, mostly of aluminum or copper, are used for cooling electronic assemblies. The devices generating power dissipation are thermally coupled to these heat sinks. If several devices are to be cooled, the same have to be mounted electrically insulated from each other, but in a thermally high-conductive manner to the heat sink, due to the electric conductivity of the heat sink. Therefore, insulation foils, mica discs, ceramic sheets, etc. are mounted between the devices to be cooled and the heat sink. Mounting methods for devices on heat sinks are screwing, bracing or adhering.

Further, individual metal parts, such as cooling plates or cooling stars, can be mounted on boards, as well as devices already provided with cooling structures. All electronic devices to be cooled that are not at a common electric potential are to obtain an individual cooling element. This results in a significant amount of components. Additionally, the reliable positioning and mechanic fixing prior to the soldering process is expensive. Additionally, due to their large heat capacity, large metallic heat sinks have negative influences on the soldering process.

Cooling electronic devices is also possible through a printed circuit board. For reducing the heat resistance through the printed circuit board, fields of vias (thermal vias) can be used. Individual heat sinks can be attached to the backside of the printed circuit board, but the printed circuit board can also be mounted flat on a cooling element (e.g. a metallic housing part). A connection with useful heat conductivity is performed by adhesion (adhesive, adhesive foil), soldering or crimping. If the printed circuit board has several copper areas with different electric potentials on the backside or if an electric insulation of the heat sink from the electronics is necessitated, for example, for safety reasons, inserting an electric insulation layer (e.g. insulation film, ceramic sheet) will be indispensable.

U.S. Pat. No. 5,973,923 describes an assembly where a printed circuit board is mounted flat on a heat sink. For avoiding short circuits, an electrically insulating and thermally high-conductive layer is provided between the printed circuit board and the heat sink.

DE 103 52 711 A1 describes an assembly consisting of a printed circuit board and a metal foam part, wherein the printed circuit board is connected to the metal foam part functioning as cooling element via a connecting layer (e.g. adhesive layer).

The attachment of individual cooling elements or the flat assembly of printed circuit boards on cooling elements by adhering or clamping is not compatible to the common assembly processes of electronics production and necessitates additional, mostly manual and, thus, expensive assembly steps. Apart from this, large-area adhering of printed circuit board and heat sink causes significant thermal-mechanical tensions due to the different coefficients of thermal expansion of the materials. The same can cause a de-lamination of the adhesive connection or the printed circuit board, respectively. Thus, the resistance to temperature changes of such an assembly is very limited.

According to an embodiment, a heat sink may have a base body provided with structures for increasing a heat-dissipating surface; a metallic molded part comprising a mounting portion, which is implemented to be mounted to or close to a heat source, and a heat-transfer portion, wherein at least the heat-transfer portion is mechanically connected to the base body, wherein the base body is made of an electrically insulating material, or wherein the base body is conductive and is electrically insulated from the metallic molded part, wherein the mounting portion protrudes from the base body and comprises a lug extending in an angle with regard to the heat-transfer or several pins, which are implemented to be inserted in vias of a printed circuit board on which the heat source is disposed.

According to another embodiment, a method for producing a heat sink may have the step of: mounting a metallic molded part comprising a mounting portion, which is implemented to be mounted to or close to a heat source, and a heat-transfer portion, which borders on the mounting portion, to a base body provided with structures for increasing a heat-dissipating surface, wherein the base body consists of an electrically insulating material, or wherein the base body is conductive and electrically insulated from the metallic molded part, wherein the mounting portion protrudes from the base body and comprises a lug extending in an angle with regard to the heat-transfer or several pins, which are implemented to be inserted in vias of a printed circuit board on which the heat source is disposed.

According to another embodiment, a method for inserting a heat source on a printed circuit board my have the step of: soldering an above-mentioned heat sink to or in thermal coupling to the heat source.

The present invention is based on the knowledge that the electrically insulated base body of the heat sink allows to process a heat sink in a simple and efficient manner. The base body cannot cause a short circuit with the metallic molded part, even when the same borders on conductive areas that are at different potentials. The base body is formed of an electrically insulating material or, alternatively, at least partly conductive, but electrically insulated, from the metallic molded part. The cooling effect and the heat-transfer effect are decoupled from the electrical conductivity of the heat sink. This decoupling is obtained by providing a separate metallic molded part having a mounting portion formed to be mounted to or close to a heat source and having a heat-transfer portion bordering on the mounting portion.

At least the heat-transfer portion is mechanically connected to the base body. Thus, due to its two-component structure, the inventive heat sink shows decoupling of the functionalities of mounting and heat transfer on the one hand, as well as heat distribution across a large surface on the other hand, which now no longer presents the danger of an electric short circuit across the heat sink.

Apart from this, due to the metallic mounting portion, the inventive heat sink can easily be implemented in a common insertion process for printed circuit boards, since common electronic devices also have metallic mounting portions, for which various mounting technologies exist, such as different soldering methods. Apart from this, the metallic mounting portion has the advantage of good thermal conductivity. Thus, heat to be dissipated is absorbed easily by the metallic mounting portion and transferred into the heat sink or the base body of electrically insulating material respectively, via the heat-transfer portion. Due to the fact that the heat-transfer portion is mechanically connected to the base body, it is ensured that the heat to be dissipated is transferred from the heat-transfer portion to the base body of electrically insulating material. Then, the base body of electrically insulating material achieves heat dissipation to the environment without short circuits being generated simultaneously by this base body.

Advantageously, for producing the heat sink, the base body of electrically insulating material and the metallic molded part are connected to each other in an injection molding process. Depending on the application and implementation, for example, for cooling several devices by one heat sink, the different cooling functionalities can be individually adjusted for the different devices, since the surface and shape of the molded parts can be optimized in a device-specific manner. Thus, a heat sink is obtained which can cool several devices simultaneously, but which has a cooling behavior adapted for every device. This ensures that devices necessitating more cooling obtain more cooling, while devices that might only have or necessitate less cooling also obtain less cooling. In this case, for example, the area of the metallic molded part included in one and the same base body would be larger for the device to be cooled more than for the device to be cooled less.

The mounting portion allows attaching of the heat sink directly on a device to be cooled or immediately adjacent to the same, for example, on a metallic conductive trace leading to a device to be cooled. The advantageous manner of attaching is soldering. Although in this case, the heat sink is not directly mounted on the device to be cooled but close to the same on a metallic conductive trace, which is a good heat conductor, still almost the same heat conductivity can be obtained compared to when the heat sink is be mounted directly on the device to be cooled. However, a great advantage of attaching the heat sink at the conductive trace via a mounting portion is that the attachment is compatible with common insertion methods for printed circuit boards and insertion machines for printed circuit boards.

Thus, the inventive heat sink can be produced in a cost-effective manner and is particularly suitable for cooling electronic devices or assemblies. Further, the inventive heat sink allows simultaneous cooling of several devices that are at different electrical potentials, wherein an individual adaptation of the heat resistance can be adjusted for every cooling path. Apart from this, the inventive heat sink is fully compatible to the common processes of electronics fabrication.

### BRIEF DESCRIPTION OF THE DRAWINGS

Embodiments of the present invention will be detailed subsequently referring to the appended drawings, in which:

FIG. 1 is a down view as well as a side view of a heat sink having three metallic molded parts;

FIG. 2 is a perspective view of a printed circuit board having two devices to be cooled and a heat sink in the non-assembled state;

FIG. 3 is an illustration of the components of FIG. 2 in the assembled state;

FIG. 4 is a down view as well as a view in the mounted state of an alternative heat sink;

FIG. 5 is an integration of a heat sink having any form in a housing;

FIG. 6 is a further illustration of an alternative heat sink having a metallic molded part with an angled mounting portion; and

FIG. 7 is a further illustration of an alternative heat sink having a metallic molded part having openings serving to avoid de-lamination of metallic molded part and base body.

### DETAILED DESCRIPTION OF THE INVENTION

An inventive cooling element consists, for example, of an insulating material, advantageously plastic, and includes at least one metallic molded part for heat introduction and heat spreading. In one embodiment, the plastic is filled with materials for improving the thermal conductivity. Appropriate filling materials are, for example, ceramic powders (BN, Al₂O₃, AIN, etc.), but also metallic powders or flakes, respectively, as well as graphite. When using electrically conductive filling materials, the filling degree is advantageously below the percolation threshold for obtaining the electrical insulation properties of the plastic. Using plastic reduces the weight and the heat capacity significantly compared to a metallic heat sink. The lower heat capacity causes fewer problems in the soldering process.

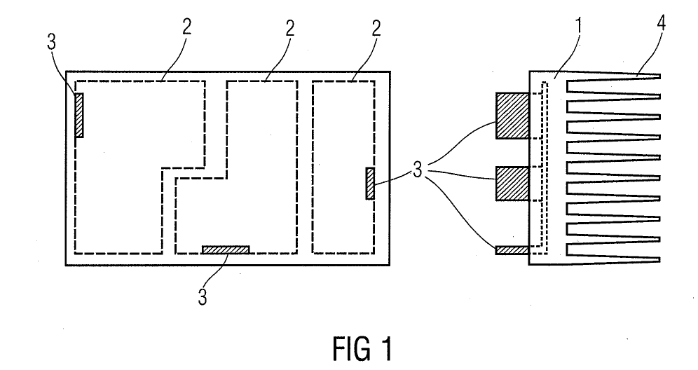

FIG. 1 shows a possible embodiment of an inventive cooling element, wherein the cooling element consists of an electrically insulating material and has at least one solderable area. In one embodiment, the cooling element is made of plastic and includes at least one metallic molded part for heat introduction and heat spreading.

The heat sink or the cooling element, respectively, includes a base body 1, for example, of an electrically insulating material (ceramic, plastic) that can be provided with any structures 4 for increasing the heat-dissipating surface. Advantageously, the base body consists of plastic filled with thermally conductive material. At least one metallic molded part 2 is injection molded in the base body 1, wherein each molded part has a protrusion or lug 3, respectively, which projects from the plastic body. Advantageously, the molded parts 2 are punch/bending parts made of 0.2 . . . 1.5 mm sheet copper. In one embodiment, all parts are punched together from a sheet metal band (lead frame technique) and are held in position via appropriate holding ridges for the injection molding process. After molding and the removal of the holding ridges, the individual molded parts 2 are electrically insulated from each other.

Due to their high heat conductivity, the metallic molded parts 2 operate like heat spreaders and, thus, provide a large area of heat introduction into the plastic body 1. By adapting the areas of the molded parts 2, the heat resistance for every molded part can be optimized individually. Lugs 3 with high heat coupling obtain respectively larger areas inside the body and, thus, use a respectively larger portion of the heat-dissipating surface of the cooling element. Due to the heat spreading effect of the metal area inside the plastic body, the heat flow density is significantly reduced. In connection with plastics filled with a thermally conductive material (specific heat conductivity 2 . . . 10 W/mK), this allows resistances to temperature changes that correspond to the one of classical aluminum heat bodies when cooling by a natural convection. At sufficiently low power dissipations, specifically filled plastics can be completely omitted.

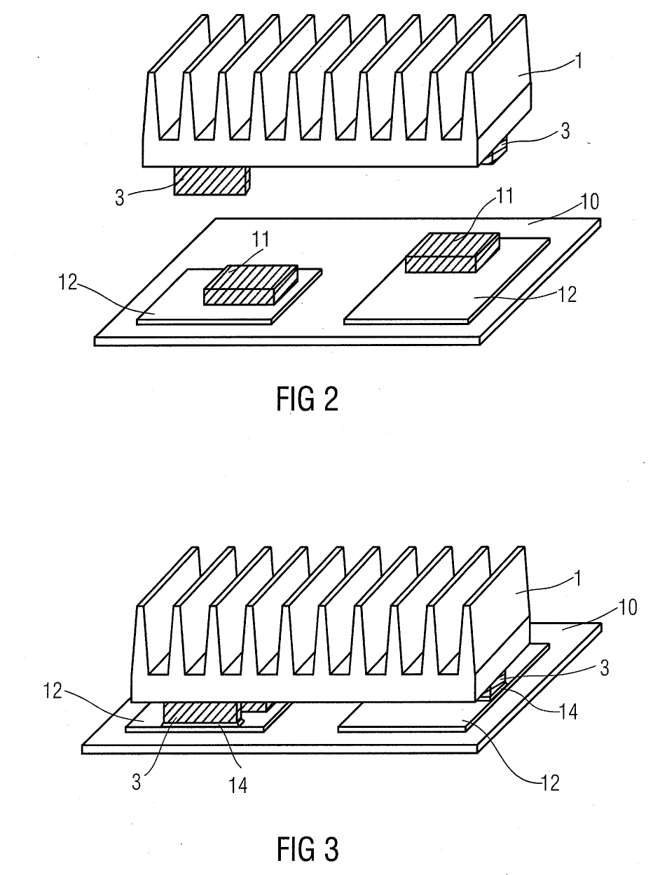

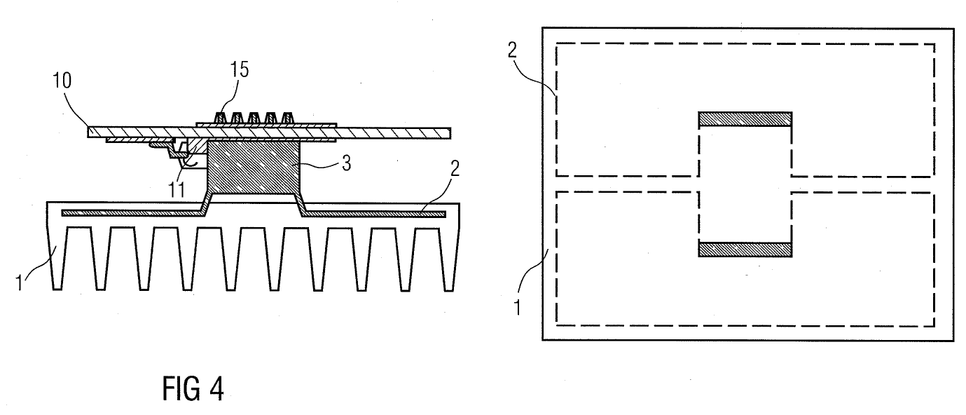

FIG. 2 shows the application of an inventive cooling element. Several power dissipation generating devices 11 at different electric potentials are on a printed circuit board 10. The devices are contacted via respective conductive traces 12. The lugs 3 of the cooling element 1 end in one plane and are positioned advantageously such that they end immediately beside the devices to be cooled in the printed circuit board. An inventive cooling element designed in such a manner can be inserted on the printed circuit board like an SMD element and can be soldered in a common soldering process together with the other devices (see FIG. 3). In cooling elements 1 for wave soldering, advantageously, pins are mounted to the lugs 3, as shown in FIG. 4 that engage in vias on the printed circuit board, like in a conventionally wired device, and that are soldered on the backside of the printed circuit board.

Inventive cooling elements 1, for example for wave, reflow or vapor-phase soldering consist of a plastic suitable for the soldering temperatures, such as PPS, LCP or post-radiation cross-linked technical thermoplastics, such as PA or PBT. Inventive cooling elements 1 for reflow or vapor-phase soldering advantageously have plane lug ends that stand either obtuse or with a little chamfer (e.g. gull-wing) on the printed circuit board.

Compared to conventional cooling elements, an inventive cooling element saves any additional mounting effort in the form of adhering, wiring or clamping and allows total omission of additional insulation materials, such as foils, mica discs, insulating bushings, etc. Even a large number of devices at different electrical potentials can be cooled with only a single cooling element.

Due to the mechanical flexibility of the lugs 3, the different coefficients of thermal expansion of the printed circuit board and the cooling element do have no negative effect on the resistance to temperature changes, as it is the case in a conventional printed circuit board, which is directly laminated on a heat sink.

In a further embodiment (see FIG. 5), the cooling element is part of a plastic housing, e.g. the housing of a flat screen or a notebook mains adapter. An inventive plastic housing 16 has, for example, injection molded sheet-like metallic molded parts 2 that project to the inside of the housing at respective parts with lugs 3. Advantageously, the lugs are provided with pin-like ends 15 on which the printed circuit board to be cooled can be inserted. Advantageously, the lugs are arranged very close to the power dissipation devices 11. Soldering the printed circuit board 10 and lugs 3, 15 is advantageously performed in a wave-soldering process.

In a further embodiment, the cooling element is part of a plastic housing and is provided with additional fixtures, e.g. latching lugs. Via the fixtures, the cooling element already connected to the printed circuit board can easily be inserted into the housing. In this way, it is possible to realize a very simple positioning and fixing of cooling element and printed circuit board. In this case, the housing can be large and formed in any manner in relation to the heat sink. If, for example, the same plastic is used for the cooling element and the device housing, the device electronics (printed circuit board) can be placed at any position in the housing without having to put up with disadvantages in the design of the overall device.

Even housings with complex free-form areas that have become more and more frequent for design and/or ergonomics reasons present no problem in contrary to conventional approaches. A housing 16 realized as the inventive cooling element allows cooling of plane circuit carriers in a very simple and effective manner by a simple adaptation of the lug lengths. According to conventional approaches, complex-shaped heat sink outlines would only be possible with very expensive technologies, such as flex printed circuit boards or 3D-MID, which are unsuitable for power electronics. Also, according to conventional approaches, thermally conductive filled foams are used as so-called “gap fillers” for cooling between irregular forms. These gap fillers are not only expensive, inserting the same necessitates additional mounting steps, and their thermal properties are significantly worse compared to the inventive solution.

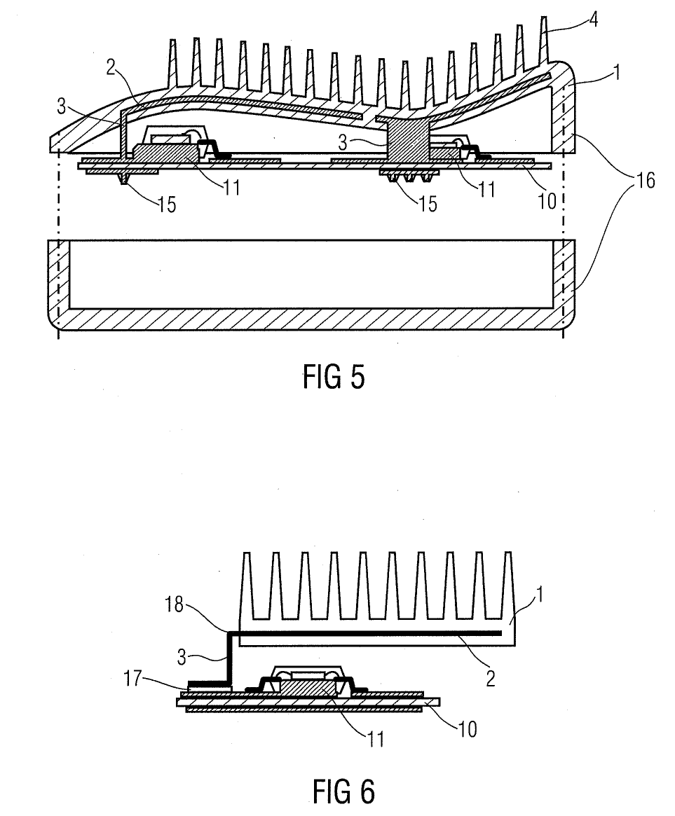

Mounting variation according to FIG. 6: Adhering the printed circuit board on the ends of the lugs 3 formed as bearing areas. The adhesive 17 is advantageously filled in a thermally conductive manner. An inventive cooling element can have metal lugs projecting from any side of the base body. In particular, lugs 3 projecting from the side 18, i.e. lying at the level of the inlay 2, are possible, a structure that is very easy to produce from a lead frame bent during an injection molding process.

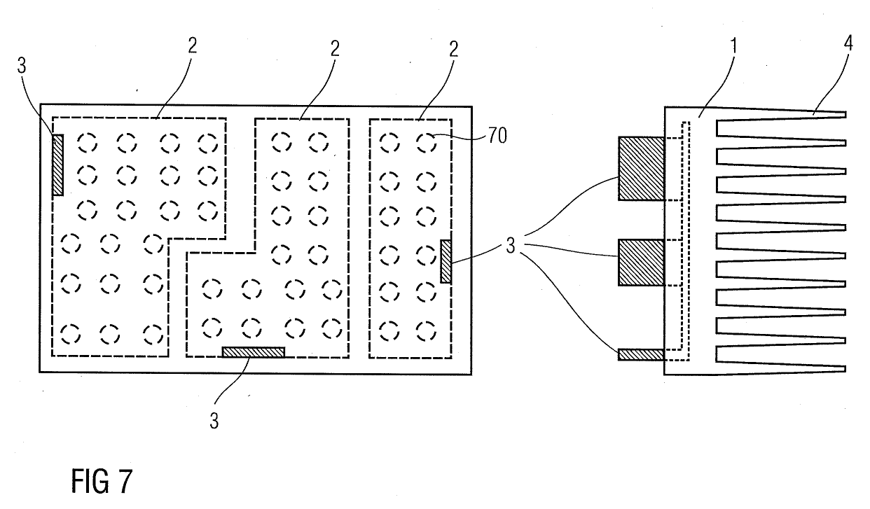

Since plastics have no or only very little adhesion to metal surfaces, de-lamination of the plastic from the metal can occur, in particular during tension due to temperature changes, due to the resulting thermo-mechanical tension at the plastic-metal interface, because of different coefficients of thermal expansion. This would significantly decrease the heat transition from metal to plastic. Thus, in a first embodiment, for improving the adhesion between metal-plastic elements, an inventive cooling element can be provided with a mechanical clamp for improving the connection. This can, for example, be obtained by specifically introduced openings 70 in the metallic molded part 2 (see FIG. 7). The openings 70 are circular or have a different shape and extend through the whole molded part.

In a second embodiment, for improving the connection, an additional adhesive layer can be deposited on the metallic molded part 2 (e.g. via ultramid 1C).

Since in many filling materials, an increase of the thermal connectivity is accompanied by an increase of the electric conductivity (e.g. with graphite), the heat sink can also be realized via a multilayer structure. Thus, an inventive cooling element can be realized, e.g., by a two-layer structure. The same consists then of an advantageous thin unfilled (and thus non-conductive) layer, which lies between the metallic molded part and a second filled layer forming the residual heat sink.

In this embodiment, the base body is conductive but electrically insulated from the molded part. In a first embodiment, this multilayer heat sink can be realized by thin electrically insulating film, which is inserted in parallel to the punch grid in the injection molding process and is molded as well. In a second embodiment, the same could be produced in a sandwich injection molding process, i.e., a layer structure with skin-core-skin-structure. In this case, the core would consist of filled plastic, the skin of unfilled plastic. Alternatively, prior to casting, the part can be immersed, for example in polyimide, which is a high quality insulator, so that an insulating continuous layer results on the part. Then, the base body, which is advantageously plastic, can be conductive. This can be obtained by a plastic filling comprising conductive particles. Typically, with more conductive particles, the electrical conductivity improves, but also the heat conductivity.

As shown in the Figs., the base body 1 comprises a lamellar heat dissipation structure. This heat dissipation structure is coupled to a heat-transfer portion 2, wherein the transfer portion 2 represents the metallic molded part together with the lug 3 or the mounting portion 3, respectively. By the thermal coupling of the heat-transfer portion 2, heat is dissipated to the heat dissipation structure 4, as can be seen, for example, in FIG. 1. Further, FIG. 1 shows that a base body can not only have 2 but also 3 or basically more molded parts 2, 3 wherein the parts are electrically insulated from each other. This is shown by the dotted lines in FIG. 2 and allows the mounting portions 3 of the individual parts to be easily deposited on non-insulating portions of a circuit having different electrical potentials, such as on conductive traces close to circuits. Depending on the implementation, the inventive heat sink can also be deposited directly on a circuit. However, in many applications, there is the advantageous possibility to solder the mounting portion 3 on a conductor close to the circuit to be cooled. Here, it is advantageous to remain relatively close to the circuit, as can be seen in FIG. 3.

In particularly advantageous embodiments, the distance between the mounting portion and the electric circuit to be cooled is less than 2 cm and advantageously less than 5 mm.

Further, it is advantageous to implement the mounting portion as resilient lug. A resilient lug can be formed in the shape of a strip or in any other resilient form to allow for a different heat extension ability of the base body on the one hand and the printed circuit board on the other hand, without any damage.

Concerning the dimensioning of the heat-transfer portion 2, a flat shape is advantageous. Further, it is advantageous that the area of a heat-transfer portion is at least 5 times the size of the area of the heat source on the circuit carrier, on or close to which the mounting portion can be mounted. Typically, as can be seen e.g. in FIG. 1, an area of the base body as large as possible is taken up by the heat-transfer portion 2, wherein different heat-transfer portions for different mounting portions are electrically insulated from each other.

Particularly in the embodiments shown in FIGS. 4 and 5, the heat-transfer portion has several pins in addition to a lug instead of a lug, which are implemented to be inserted in vias of a printed circuit board, on which the heat source is disposed. Further, it is advantageous to form the mounting portion in a soldering manner, which means to provide the same with a surface having a hydrophilic surface property for the intended soldering material.

Concerning the production of the heat sink, it is advantageous to produce the metallic molded part first and then mount the same to a base body of electrically insulating material, wherein producing the base body and mounting the metallic molded part can be performed in one step, namely when the metallic molded part is molded by injection molding or, for example, is molded with a duroplast. Alternatively, the metallic molded part can be mounted separately to a base body, after the base body has been produced, for example by adhering or by screwing, etc. The metallic molded part is advantageously produced by punching and bending, via process steps as they are known for processing lead frames. For individually optimizing the heat dissipation characteristic of a heat sink having to cool several heat sources, it is advantageous to predetermine a heat dissipation characteristic for each heat source of a plurality of heat sources. Then, one area per molded part is individually optimized for providing the predetermined heat dissipation characteristic for each heat source. Then, based on the results of the step of optimizing, the molded parts are produced and mounted together on a base body, for example by placing in an injection molding form and subsequent molding of the several parts, for example for producing a heat sink as shown in FIG. 1 or FIG. 4.

For inserting on a printed circuit board with a heat source, it is advantageous to solder the heat sink, directly at a heat source or at least thermally coupled to a heat source. Soldering the heat sink takes place by soldering the mounting portion to a conductive trace or to the heat source itself. Alternatively, the heat sink can also be mounted to the conductive trace or the heat source directly by a thermally conductive filled adhesive.

Thus, according to embodiments, the heat sink provides, among others, the following advantages: several devices being at different electrical potentials can be cooled with a single cooling element; saving of additional mounting effort; omission of additional individual insulation materials, such as films, micro discs, insulating bushings, etc.; low thermo-mechanical stress at the interface to the printed circuit board by the mechanical resilience of the lugs and thus, increased resistance to temperature changes; and novel design possibilities.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A heat sink, comprising:
a base body provided with structures for increasing a heat-dissipating surface;
a metallic molded part comprising a mounting portion, which is implemented to be mounted to or close to a heat source, and a heat-transfer portion, wherein at least the heat-transfer portion is mechanically connected to the base body,
wherein the base body is made of an electrically insulating material, or
wherein the base body is conductive and is electrically insulated from the metallic molded part,
wherein the mounting portion protrudes from the base body and comprises a lug extending in an angle with regard to the heat-transfer or several pins, which are implemented to be inserted in vias of a printed circuit board on which the heat source is disposed.

2. The heat sink according to claim 1, wherein the electrically insulating material of the base body comprises plastic provided with thermally conductive filling materials.

3. The heat sink according to claim 1, wherein the base body and the metallic molded part are produced by a plastic injection molding process and are connected to each other.

4. The heat sink according to claim 1, wherein the metallic molded part is adhered to a surface of the base body.

5. The heat sink according to claim 1, wherein the metallic molded part is screwed, crimped or connected in another form-fitting manner to the base body.

6. The heat sink according to claim 1, wherein the metallic molded part is provided with openings surrounded by the electrically insulating material of the base body.

7. The heat sink according to claim 1, wherein the metallic molding part is provided with an adhesive layer.

8. The heat sink according to claim 1, wherein the electrically insulating material of the base body comprises a multilayer structure.

9. The heat sink according to claim 1, wherein the electrically insulating material of the base body comprises a multilayer structure, which is produced by inserting and molding electrically insulating films with an injection molding process.

10. The heat sink according to claim 1, wherein the electrically insulating material of the base body comprises a multilayer structure, which is produced by a skin-core-skin structure during the injection molding process, and the skin comprises electrically non-conductive plastic and the core electrically conductive plastic.

11. The heat sink according to claim 1, wherein the metallic molded part comprises an insulator coating, and is embedded in the base body together with the insulator coating.

12. The heat sink according to claim 11, wherein the metallic molded part has been immersed in polyimide and has subsequently been molded.

13. The heat sink according to claim 1, which is mounted on a printed circuit board like a wired device (THD device).

14. The heat sink according to claim 1, which is mounted on a printed circuit board like an SMD device.

15. The heat sink according to claim 1, wherein the mounting portion is implemented as a lug, which projects in an angle with regard to the heat-transfer portion.

16. The heat sink according to claim 1, which is implemented to form a housing part for an electronic circuit.

17. The heat sink according to claim 1, which comprises additional fixtures, which are implemented to connect the metallic molded part with or without the printed circuit board connected thereto to a housing part.

18. The heat sink according to claim 1, which comprises additional fixtures, such as latching lugs, and is shaped such that the same can be inserted in a recess provided therefore in a housing, and is held in a stable manner by latching of the additional fixtures.

19. The heat sink according to claim 1, wherein the base body comprises a lamellar heat dissipation structure, which is thermally coupled to the heat-transfer portion.

20. The heat sink according to claim 1 comprising a further metallic molded part, which is electrically insulated from the metallic molded part.

21. The heat sink according to claim 1, wherein the lug is implemented as resilient lug, which comprises such an elasticity that the same is elastically deflected by a difference of coefficients of thermal extension between the heat sink and the heat source.

22. The heat sink according to claim 1, wherein the heat-transfer portion comprises a flat shape, wherein an area of the heat-transfer portion is at least five times the size of an area of a heat source of a circuit carrier on or close to which the mounting portion can be mounted.

23. The heat sink according to claim 1, wherein the mounting portion is implemented in a solderable manner.

24. The heat sink according to claim 23, wherein the mounting portion comprises a surface characteristic wettable for solder.

25. A method for producing a heat sink, comprising:
mounting a metallic molded part comprising a mounting portion, which is implemented to be mounted to or close to a heat source, and a heat-transfer portion, which borders on the mounting portion, to a base body provided with structures for increasing a heat-dissipating surface, wherein the base body comprises an electrically insulating material, or wherein the base body is conductive and electrically insulated from the metallic molded part, wherein the mounting portion protrudes from the base body and comprises a lug extending in an angle with regard to the heat-transfer or several pins, which are implemented to be inserted in vias of a printed circuit board on which the heat source is disposed.

26. The method according to claim 25, wherein the electrically insulating material is plastic and the step of mounting comprises molding or casting the metallic molded part via a plastic injection molding method or a casting method.

27. The method according to claim 25, wherein the metallic molded part is produced by punching and bending.

28. The method according to claim 27, wherein the metallic molded part comprises holding ridges for a cast process prior to mounting the metallic molded part, wherein the holding ridges are removed after casting or molding the metallic molded part.

29. The method according to claim 25, wherein the metallic molded part is immersed into an insulator, such as polyimide, whereupon the step of mounting takes place by molding or casting, such that the metallic molded part is electrically insulated from the base body and the base body is implemented in a conductive manner.

30. The method according to claim 25, wherein several molded parts are provided, the method comprising:
predetermining a heat dissipation characteristic for every heat source of a plurality of heat sources;
optimizing an area per molded part, for providing an approximation to the predetermined heat dissipation characteristic for every molded part; and
producing the molded parts after the step of optimizing and prior to the step of mounting.

31. A method for inserting a heat source on a printed circuit board, comprising:
soldering a heat sink comprising:
a base body provided with structures for increasing a heat-dissipating surface;
a metallic molded part comprising a mounting portion, which is implemented to be mounted to or close to a heat source, and a heat-transfer portion, wherein at least the heat-transfer portion is mechanically connected to the base body,
wherein the base body is made of an electrically insulating material, or
wherein the base body is conductive and is electrically insulated from the metallic molded part,
wherein the mounting portion protrudes from the base body and comprises a lug extending in an angle with regard to the heat-transfer or several pins, which are implemented to be inserted in vias of a printed circuit board on which the heat source is disposed,
to or in thermal coupling to the heat source.

32. The method according to claim 30, wherein the heat source is a device on a printed circuit board, wherein the printed circuit board comprises a conductive trace to the device, and
wherein soldering takes place by soldering the mounting portion to the conductive trace close to the device.

33. The method according to claim 32, wherein the mounting portion is soldered on the conductive trace in less than 1 cm distance from the heat source.

34. The method according to claim 31, wherein the heat sink comprises several metallic molded parts, which are connected to a base body, wherein the printed circuit board comprises several heat sources at different potentials, and wherein after a step of inserting the heat sink on the printed circuit board, mounting portions of the several metallic molded parts are soldered to or close to the respective heat sources.
